(19) United States
(12) Patent Application Publication
(10) Pub. No.: US 2016/0209966 A1
(43) Pub. Date: Jul. 21, 2016

(54) DISPLAY DEVICE INCLUDING TOUCH SENSOR AND DRIVING METHOD THEREOF

(71) Applicant: Samsung Display co., Ltd., Yongin-si (KR)

(72) Inventor: Chan Sung JUNG, Seoul (KR)

(21) Appl. No.: 14/850,758

(22) Filed: Sep. 10, 2015

(30) Foreign Application Priority Data
Jan. 16, 2015 (KR) 10-2015-0008164

(51) Int. Cl. G06F 3/047; G06F 3/044

(52) U.S. Cl. CPC G06F 3/047; G06F 3/044; G06F 2203/04103; G06F 2203/04112

(57) ABSTRACT

The display device according to an exemplary embodiment includes: a plurality of touch sensors having touch electrodes formed therein, each of the touch electrodes configured to be charged by a touch driving signal and discharged by a touch of a conductor; a plurality of filter units connected to the plurality of touch sensors, respectively, the filter units configured to have a pass band different from one another and to pass the touch driving signal to a connected touch sensor when the frequency of the touch driving signal is in the pass band; a signal wiring connected to the plurality of filter units and outputting the touch driving signal to the plurality of filter units; and a touch controlling unit connected to the signal wiring and sequentially applying touch driving signals having different frequencies to the signal wiring.

### CROSS-REFERENCE TO RELATED APPLICATION

This application claims priority to and the benefit of Korean Patent Application No. 10-2015-0008164 filed in the Korean Intellectual Property Office on Jan. 16, 2015, the entire contents of which are incorporated herein by reference.

### BACKGROUND

(a) Field

The present disclosure relates to a display device including a touch sensor and a driving method thereof.

(b) Description of the Related Art

In addition to displaying an image, a display device may include a touch sensing function that enables a user to interact with the display device. The touch sensing function detects touch information such as whether or not an object touches a screen of the display device, the location where the touch occurred, and the like. For example, when the user touches the screen using a finger, a touch pen, or the like, such as to write a letter or draw a picture on the screen, the touch sensing function may detect touch information by sensing a change in pressure applied to the screen, a change in the amount of charge stored in underlying capacitors, a change in the light, or the like. The display device may receive an image signal based on the touch information.

The touch sensing function may be implemented using a touch sensor. The touch sensor may function as one or more of various types such as a resistive type, a capacitive type, an electro-magnetic (EM) type, an optical type, and the like.

The touch sensor of the capacitive type includes touch electrodes and senses a change in capacitance of the touch electrode generated when a conductor, such as the user's finger, approaches the sensor, thereby detecting whether or not the conductor touches the sensor, the touch location thereof, and the like.

However, a touch screen panel (TSP) of the capacitive type according to the related art requires one signal line and a compression pad part for each one sensor region, that is, every touch sensor.

Therefore, when there is a great number of touch sensors, using a flexible PCB (FPCB) as a connection part between a touch integrated circuit (IC) and the touch screen panel may not be feasible. Instead, an expensive chip on flexible printed circuit (COF) is generally used. In addition, as the number of touch sensors is increased, a compression error rate and performance deterioration due to an increase of a dead space through which the signal line passes for each touch sensor may be caused. In this case, since the dead space does not have the touch sensor, sensitivity in the dead space is decreased.

The above information disclosed in this Background section is only for enhancement of understanding of the background of the disclosure and therefore may contain information that does not form the prior art that is already known in this country to a person of ordinary skill in the art.

### SUMMARY

The present disclosure provides a display device including a touch sensor and a driving method thereof that advantageously reduce the number of signal lines and compression pad parts in a capacitive type touch screen panel (TSP).

An exemplary embodiment of the present system and method provides a display device including: a plurality of touch sensors having touch electrodes formed therein, each of the touch electrodes configured to be charged by a touch driving signal and discharged by a touch of a conductor; a plurality of filter units connected to the plurality of touch sensors, respectively, the filter units configured to have a pass band different from one another and to pass the touch driving signal to a connected touch sensor when the frequency of the touch driving signal is in the pass band; a signal wiring connected to the plurality of filter units and outputting the touch driving signal to the plurality of filter units; and a touch controlling unit connected to the signal wiring and sequentially applying touch driving signals having different frequencies to the signal wiring.

The touch controlling unit may include:

a touch driving signal outputting module configured to generate the touch driving signals having the different frequencies by varying a voltage and a frequency and outputting the touch driving signals to the signal wiring; a touch sensing signal inputting module configured to receive a touch sensing signal through the signal wiring when capacitance of the touch electrode is changed by a discharge due to a touch; and a control module configured to determine a location of the touch sensor at which the touch sensing signal is generated based on the frequency of the touch sensing signal.

The touch controlling unit may further include:

a storing unit configured to map and store frequency information of the touch driving signal mapped to location information of each of the plurality of touch sensors; and

the control module may be configured to determine the location of the touch sensor by obtaining the location information of the touch sensor from the storing unit using the frequency information of the touch sensing signal received from the touch sensing signal inputting module.

The plurality of filter units may include:

a resistor element connected to the signal wiring; an inductor element connected in series with the resistor element; and a capacitor element connected in series with the inductor element.

The resistor element, the inductor element, and the capacitor element may be formed of a transparent material.

The plurality of touch sensors may be touch sensors of a self-capacitance type.

The plurality of touch sensors may be touch sensors of a mutual capacitance type.

Another embodiment of the present system and method provides a driving method of a display device, the display device including a plurality of touch sensors having touch electrodes formed therein, the touch electrodes configured to be charged by a touch driving signal having a specific frequency and discharged by a touch of a conductor, a plurality of filter units connected to the plurality of touch sensors, respectively, and a signal wiring connected to the plurality of filter units, the driving method including: generating and applying the touch driving signal having the specific frequency to the signal wiring; and passing and supplying the touch driving signal, by a filter unit, to a touch electrode connected to the filter unit, while blocking the touch driving signal from being passed to other touch electrodes by other filter units, based on the specific frequency of the touch driving signal.

The driving method may further include, after the passing and supplying of the touch driving signal to the touch electrode,

receiving a touch sensing signal through the signal wiring when capacitance of the touch electrode is changed by a discharge due to a touch; and determining a location of the touch sensor at which the touch sensing signal is generated based on a frequency of the touch sensing signal.

The driving method may further include, before the generating of the touch driving signal,

mapping and storing frequency information of the touch driving signal to location information of each of the plurality of touch sensors,

wherein the determining of the location of the touch sensor may include:

obtaining location information of the touch sensor mapped to the frequency information of the received touch sensing signal, and determining the touch sensor in which the touch occurs based on the location information.

The applying of the touch driving signal may include:

sequentially applying a plurality of touch driving signals having different frequencies to the signal wiring, and

the supplying of the touch driving signal, the receiving of the touch sensing signal, and the determining of the location of the touch sensor may be repeated for each of the plurality of touch driving signals.

According to an embodiment of the present system and method, since the plurality of touch sensors may be connected to one signal line, cost improvement may be prompted by a decrease in costs of the flexible PCB (FPCB), and performance improvement may be prompted by a decrease in the dead space. For example, if ten touch sensors may be connected to one signal line, the number of signal lines and compression pad parts may be reduced to 1/10 of that in the case of the related art.

### BRIEF DESCRIPTION OF THE DRAWINGS

FIG. 1 is a block diagram of a display device including a touch sensor according to an exemplary embodiment of the present system and method.

FIG. 2 is a block diagram of a display device including a touch sensor according to another exemplary embodiment of the present system and method.

FIG. 3 is a circuit diagram of a filter unit in FIGS. 1 and 2.

FIG. 4 is a graph showing a gain of the filter unit in FIGS. 1 and 2.

FIG. 5 is a block diagram showing a configuration of a touch controlling unit in FIGS. 1 and 2.

FIG. 6 shows a configuration of a touch information storing unit in FIG. 5.

FIG. 7 is a flowchart showing a driving method of a display device according to an exemplary embodiment of the present system and method.

### DETAILED DESCRIPTION OF THE EMBODIMENTS

In the following detailed description, certain exemplary embodiments of the present system and method are shown and described for the purpose of illustration. However, the present system and method may be implemented in various different forms and are not limited to the exemplary embodiments described in the present specification. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, imply the inclusion of stated elements but not the exclusion of any other elements.

Throughout this specification and the claims that follow, when it is described that an element is “coupled” to another element, the element may be “directly coupled” to the other element or “electrically coupled” to the other element through a third element.

Hereinafter, a display device including a touch sensor and a driving method thereof according to exemplary embodiments of the present system and method is described in with reference to the accompanying drawings.

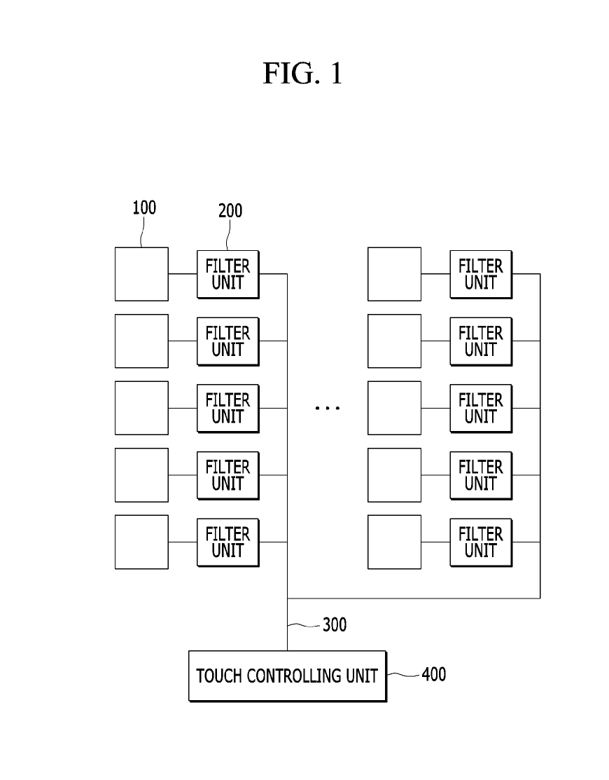

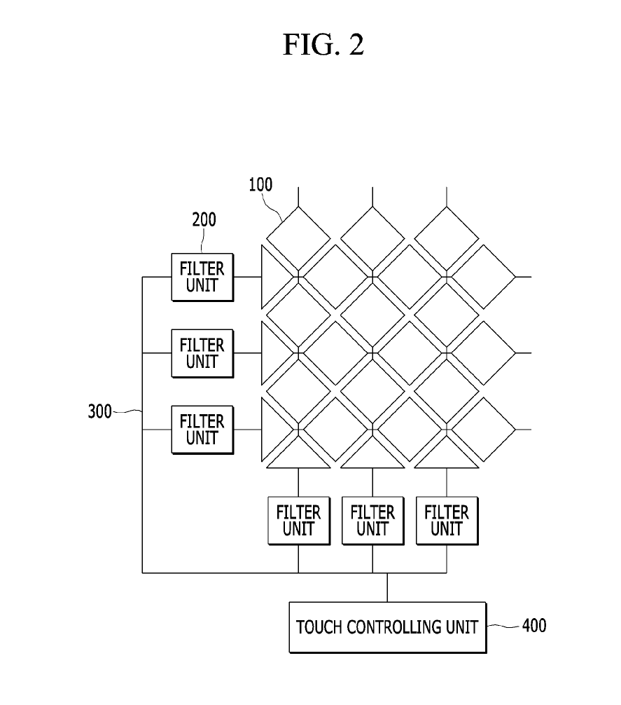

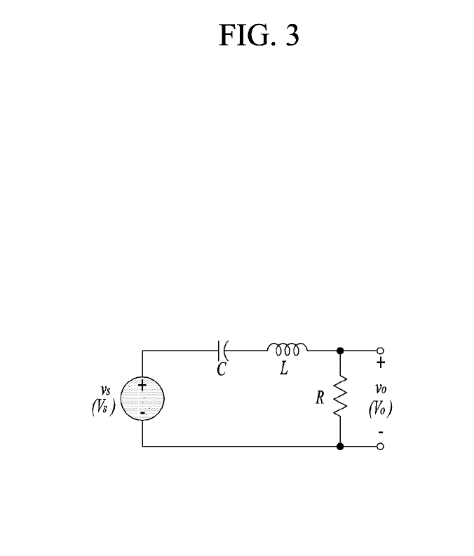

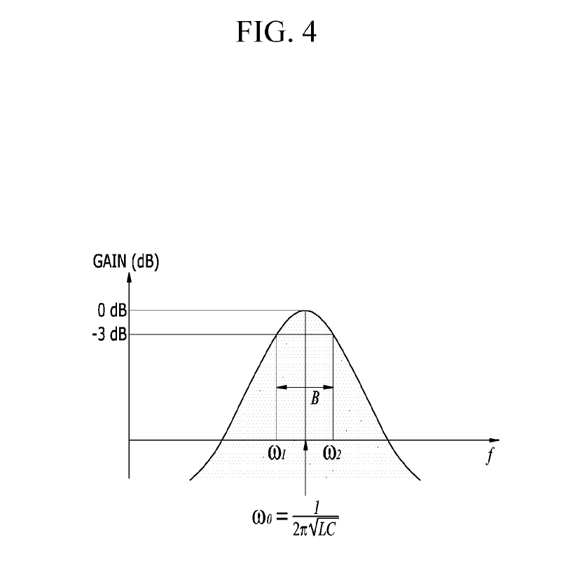

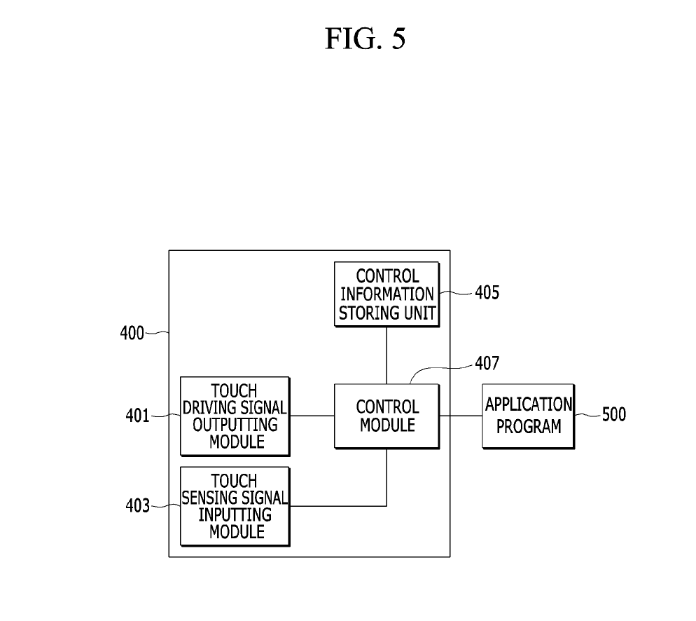

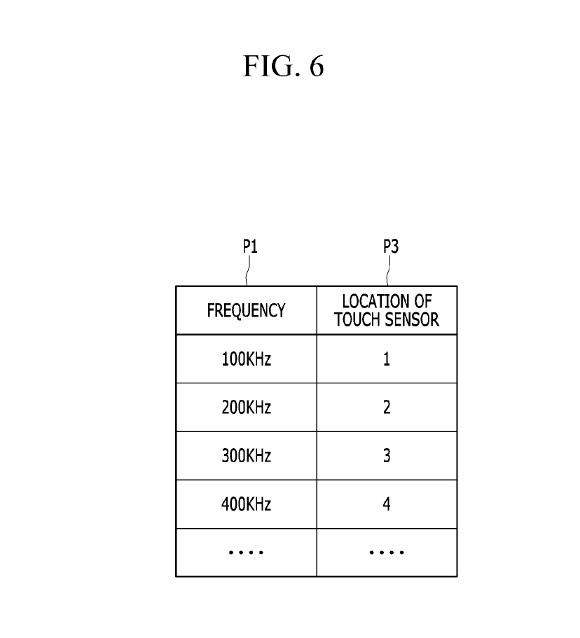

FIG. 1 is a block diagram of a display device including a touch sensor according to an exemplary embodiment of the present system and method. FIG. 2 is a block diagram of a display device including a touch sensor according to another exemplary embodiment of the present system and method. FIG. 3 is a circuit diagram of a filter unit in FIGS. 1 and 2. FIG. 4 is a graph showing a gain of the filter unit in FIGS. 1 and 2. FIG. 5 is a block diagram showing a configuration of a touch controlling unit in FIGS. 1 and 2. FIG. 6 shows a configuration of a touch information storing unit in FIG. 5.

Referring to FIGS. 1 and 2, a display device includes a plurality of touch sensors 100, a plurality of filter units 200, a signal wiring 300, and a touch controlling unit 400.

The plurality of touch sensors 100 are formed in a region of a capacitive touch screen panel where an object, such as a hand, a pen, or the like, may touch and sense whether and where a touch is made.

The plurality of touch sensors 100 have touch electrodes (not shown) formed therein. The touch sensor 100 charges the touch electrode (not shown) therein according to a touch driving signal having a specific frequency. Thereafter, when the area of the capacitive screen panel corresponding to the touch electrode is touched by a conductor, the capacitance formed in the touch electrode is changed. Particularly, charges charged in the touch electrode (not shown) are discharged by the touch of the conductor, and a change in the amount of charge occurs. Then, the touch sensor 100 outputs a touch sensing signal according to the discharge.

The touch sensor TS may have a length of about several millimeters (mm), for example, about 4 to 5 mm. The size of the touch sensor TS may be changed depending on touch sensing resolution.

The plurality of touch sensors 100 may be touch sensors of a self-capacitance type, each of which is isolated and measures the capacitance of one touch sensor, as shown in FIG. 1

Alternatively, as shown in FIG. 2, the touch sensor 100 may be a touch sensor of a mutual capacitance type, which senses the capacitance between two sensor patterns.

In the case of FIG. 2, the plurality of touch sensors 100 may be made of a transparent conductor, such as ITO, IZO, a carbon nano tube, or the like, and have a quadrangular shape, a circular shape, a triangular shape, a star shape, a fractal configuration, or the like. According to one embodiment, the touch sensor 100 and the signal wiring 300 are formed of the same material.

The plurality of filter units 200 are connected to the plurality of touch sensors 100, respectively. That is, one filter unit 200 is connected to one touch sensor 100. In addition, the filter unit 200 is selectively input with the touch driving signal.

Each of the filter units 200 may be configured to pass a touch driving signal having a frequency in a particular frequency range to the touch sensor 100 connected thereto and block touch driving signals having a frequency outside of the particular frequency range. For example, a first filter unit 200 may be configured to pass a touch driving signal having a first frequency to a first touch sensor connected thereto. However, the remaining plurality of filter units 200 may be configured pass touch driving signals in different frequency ranges that do not encompass the first frequency. Thus, the remaining plurality of filter units 200 block the touch driving signal having the first frequency, and the touch driving signal having the first frequency is not transferred to the other touch sensors 100.

The filter unit 200 is configured by a resistor element R, an inductor element L, and a capacitor element C, as shown in FIG. 3. In this case, the resistor element R is connected to the signal wiring 300. The inductor element L is connected in series with the resistor element R, and the capacitor element C is connected in series with the inductor element L.

The filter unit 200 passes only a signal having a matching frequency (or frequency range) and blocks signals having mismatching frequencies (or frequency range) by the configuration of the resistor element R, the inductor element L, and the capacitor element C. The resistor element R may be replaced with a signal line connecting wiring part. The inductor element L and the capacitor element C may be made of a transparent electrode material.

The filter unit 200 may passes only a specific frequency (or frequency range) by using resonance characteristics of the resistor element R, the inductor element L, and the capacitor element C.

In this case, as shown in Table 1, when a low frequency signal is applied, the reactance of the capacitor element C is large, and the reactance of the inductor element L is small. On the other hand, when a high frequency signal is applied, the reactance of the capacitor element C is small, and the reactance of the inductor element L is large. As such, when the capacitor element C and the inductor element L is connected in series, a band-pass filter is formed. The pass band, or frequency range that is not effectively blocked, of the filter unit 200 varies depending on the capacitance of the capacitor element C and the inductance of the inductor element L.

TABLE 1

| | C | L |
|---|---|---|
| Low Frequency | Large Resistance | Small Resistance |
| High Frequency | Small Resistance | Large Resistance |

In this case, a gain of the filter unit 200 may be defined by the following Equation 1.

$$H ( jω ) = \frac{{V}_{o}}{{V}_{s}} = \frac{R}{Z + R} = \frac{R}{R + j ( ω L - 1 / ω C )} \\ \vert H ( jω ) \vert = \{ \begin{matrix}0 , & ω = 0 \\ 1 , & ω = {ω}_{o} \\ 0 , & ω = ∞\end{matrix} \qquad ( Equation 1 )$$

Here, H indicates a transfer function, V_{S} indicates an input of the filter unit 200, V_{O} indicates an output of the filter unit 200, R indicates a resistance value, Z indicates impedance of LC, ω indicates a frequency, L indicates a value of an inductor, and C indicates a value of a capacitor.

Referring to FIG. 4, the gain of a filter unit is 1 (i.e., 0 dB), which is the maximum, when the frequency ω of the input V_{S} of the filter unit is equal to a resonance frequency ω₀. Frequencies ω₁ and ω₂ correspond to frequencies at which the gain of the filter is −3 dB. That is, when the frequency ω of V_{S} is ω₁ or ω₂, the power of the output V_{O} of the filter unit is reduced to ½ of its input V_{S}. ω₁-ω₂ is referred to as a bandwidth of the filter unit.

The resistor element R, the inductor element L, and the capacitor element C for configuring the filter unit 200, which is a band-pass filter, may be transparent for visibility. The resistor element R may be implemented by adjusting a thickness and a length of a transparent electrode. In addition, the capacitor element C may be a flexible transparent insulated capacitor having a nano-structure electrode. Here, the flexible transparent insulated capacitor is made by using a technique in which a single wall nano tube and a silver nano wire are sprayed. The capacitor configured of the single wall nano tube electrode may have optical transparency of 57 to 74%, capacitance of 0.4 to 1.1 μF/cm², and series resistance of 400 to 10000 ohm/sq.

Referring to again FIGS. 1 and 2, the plurality of filter units 200 are connected to the signal wiring 300, and the signal wiring 300 is connected to the touch controlling unit 400.

As such, the plurality of touch sensors 100 share the signal wiring that is input with the touch driving signal. According to an exemplary embodiment, the signal wiring consists of one signal wiring.

The signal wiring 300 outputs a touch driving signal having a specific frequency generated by the touch controlling unit 400 to the plurality of filter units 200. In addition, the signal wiring 300 outputs a touch sensing signal having a specific frequency that passes through the plurality of filter units 200 to the touch controlling unit 400.

The touch controlling unit 400 is connected to the signal wiring 300 and sequentially applies touch driving signals having different frequencies to the signal wiring 300.

The touch controlling unit 400 supplies the touch driving signals for touch sensing to the plurality of touch sensors 100 connected to the signal wiring 300. In addition, the touch controlling unit 400 detects whether or not the capacitive touch screen panel is touched and a touch location by sensing a change in capacitance due to the touch through the touch electrodes (not shown).

The touch controlling unit 400 generates a plurality of touch driving signals having different frequencies based on a touch control signal (TCS) that is input from a timing controller (not shown).

In this case, the touch controlling unit 400 may include the configuration shown in FIG. 5.

Referring to FIG. 5, the touch controlling unit 400 includes a touch driving signal outputting module 401, a touch sensing signal inputting module 403, a control information storing unit 405, and a control module 407.

The touch driving signal outputting module 401 generates touch driving signals having different frequencies by varying a voltage and a frequency and outputs the touch driving signals to the signal wiring 300.

If capacitance of the touch electrode is changed by a discharge due to a touch, the touch sensing signal inputting module 403 is input with a touch sensing signal that depends on the change through the signal wiring 300.

The control information storing unit 405 maps and stores frequency information of the touch driving signal to each location information of the plurality of touch sensors 100. The control information storing unit 405 may implement a table type database, as shown in FIG. 6.

Referring to FIG. 6, the control information storing unit 405 stores location information P3 of the touch sensor 100 connected to the filter unit 200 and the specific frequency P1 of the touch driving signal that the filter unit 200 passes. For example, a first touch sensor 100 is connected to a first filter unit 200 that passes a touch driving signal having a frequency of 100 KHz. In addition, a second touch sensor 100 is connected to a second filter unit 200 that passes a touch driving signal having a frequency of 200 KHz. As such, the plurality of touch sensors 100 are each selectively supplied with only the touch driving signal having the frequency that is allowed by each of the corresponding filter units 200.

Referring to again FIG. 5, the control module 407 generates and outputs the touch driving signal and is input with the touch sensing signal. In this case, the control module 407 determines the touch location based on the frequency of the touch sensing signal and collects the determined touch location information so as to be applied to an application program 500, thereby generating touch screen information.

The control module 407 determines the touch sensor in which the touch occurs by obtaining location information of the touch sensor 100, which is mapped to the frequency information of the touch sensing signal received from the touch sensing signal inputting module 403, from the storing unit 405.

The control module 407 may define a reference by calculating a coordinate of a point at which the touch occurs based on the location information of the touch sensor 100 that responds to each touch driving signal.

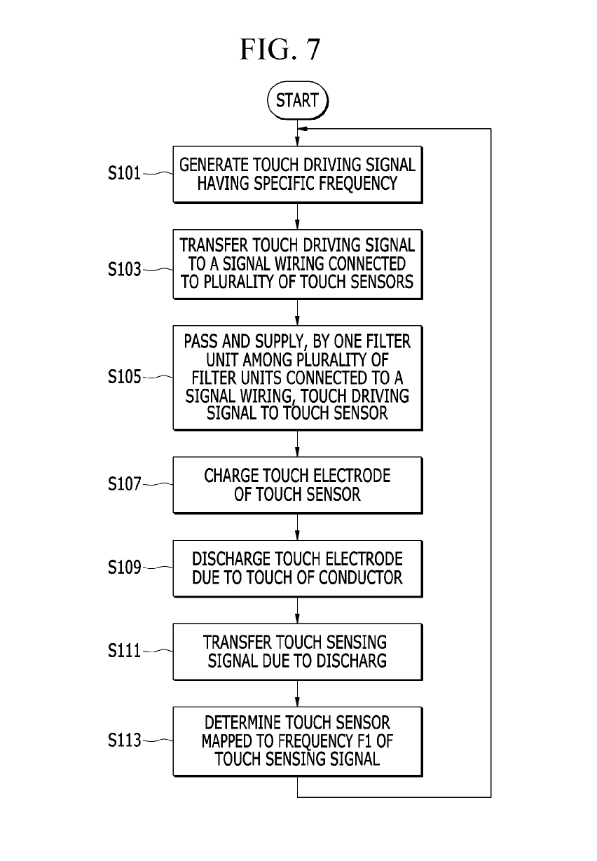

FIG. 7 is a flowchart showing a driving method of a display device according to an exemplary embodiment of the present system and method.

Referring to FIG. 7, the touch controlling unit 400 generates a touch driving signal having a specific frequency (S101).

The touch controlling unit 400 transfers the touch driving signal generated in S101 to the signal wiring 300 connected to the plurality of touch sensors 100 (S103).

Only the filter unit 200 configured to pass the frequency of the touch driving signal generated in S101 among the plurality of filter units 200 connected to the signal wiring 300 passes the touch driving signal generated in S101 and supplies the touch driving signal to the touch sensor 100 to which the filter unit 200 is connected (S105).

Charges are charged in the touch electrode of the touch sensor 100 according to the touch driving signal supplied from S105 (S107).

If the touch electrode is discharged due to the contact touch (S109), the touch sensor 100 transfers the touch sensing signal due to the discharging to the touch controlling unit 400 through the signal wiring 300 (S111).

The touch controlling unit 400 determines the location of the touch sensor mapped to the frequency of the touch sensing signal received from S111 (S113).

The touch controlling unit 400 generates touch driving signals having different frequencies and sequentially applies the touch driving signals having different frequencies to the signal wiring 300. Therefore, S101 to S113 are repeated for each of the frequencies corresponding to each of the touch sensors 100.

The exemplary embodiments of the present system and method described above may be implemented by a program, or a recording medium having the program recorded therein, that realizes functions corresponding to the configurations of the exemplary embodiments of the present system and method.

While the present system and method are described in connection with exemplary embodiments, the present system and method are not limited to the disclosed embodiments, but, on the contrary, are intended to cover various modifications and equivalent arrangements included within the spirit and scope of the appended claims.

What is claimed is:

1. A display device comprising:
a plurality of touch sensors having touch electrodes formed therein, each of the touch electrodes configured to be charged by a touch driving signal and discharged by a touch of a conductor;
a plurality of filter units connected to the plurality of touch sensors, respectively, the filter units configured to have a pass band different from one another and to pass the touch driving signal to a connected touch sensor when the frequency of the touch driving signal is in the pass band;
a signal wiring connected to the plurality of filter units and outputting the touch driving signal to the plurality of filter units; and
a touch controlling unit connected to the signal wiring and sequentially applying touch driving signals having different frequencies to the signal wiring.

2. The display device of claim 1, wherein the touch controlling unit includes:
a touch driving signal outputting module configured to generate the touch driving signals having the different frequencies by varying a voltage and a frequency and outputting the touch driving signals to the signal wiring;
a touch sensing signal inputting module configured to receive a touch sensing signal through the signal wiring when capacitance of the touch electrode is changed by a discharge due to a touch; and
a control module configured to determine a location of the touch sensor at which the touch sensing signal is generated based on the frequency of the touch sensing signal.

3. The display device of claim 2, wherein the touch controlling unit further includes:
a storing unit configured to map and store frequency information of the touch driving signal to location information of each of the plurality of touch sensors; and
the control module is configured to determine the location of the touch sensor by obtaining the location information of the touch sensor from the storing unit using frequency information of the touch sensing signal received from the touch sensing signal inputting module.

4. The display device of claim 1, wherein the plurality of filter units include:
a resistor element connected to the signal wiring;
an inductor element connected in series with the resistor element; and
a capacitor element connected in series with the inductor element.

5. The display device of claim 4, wherein:
the resistor element, the inductor element, and the capacitor element are formed of a transparent material.

6. The display device of claim 1, wherein the plurality of touch sensors are touch sensors of a self-capacitance type.

7. The display device of claim 1, wherein the plurality of touch sensors are touch sensors of a mutual capacitance type.

8. A driving method of a display device, the display device including:
a plurality of touch sensors having touch electrodes formed therein, the touch electrodes configured to be charged by a touch driving signal having a specific frequency and discharged by a touch of a conductor, a plurality of filter units connected to the plurality of touch sensors, respectively, and a signal wiring connected to the plurality of filter units, the driving method comprising:
generating and applying the touch driving signal having the specific frequency to the signal wiring; and
passing and supplying the touch driving signal, by a filter unit, to a touch electrode connected to the filter unit, while blocking the touch driving signal from being passed to other touch electrodes by other filter units, based on the specific frequency of the touch driving signal.

9. The driving method of claim 8, further comprising:
after the passing and supplying of the touch driving signal to the touch electrode,
receiving a touch sensing signal through the signal wiring when capacitance of the touch electrode is changed by a discharge due to a touch; and
determining a location of the touch sensor at which the touch sensing signal is generated based on the frequency of the touch sensing signal.

10. The driving method of claim 9, further comprising:
before the generating of the touch driving signal,
mapping and storing frequency information of the touch driving signal to location information of each of the plurality of touch sensors,
wherein the determining of the location of the touch sensor includes:
obtaining location information of the touch sensor mapped to the frequency information of the received touch sensing signal, and
determining the touch sensor in which the touch occurs based on the location information.

11. The driving method of claim 10, wherein the applying of the touch driving signal includes:
sequentially applying a plurality of touch driving signals having different frequencies to the signal wiring, and
the supplying of the touch driving signal, the receiving of the touch sensing signal, and the determining of the location of the touch sensor are repeated for each of the plurality of touch driving signals.
